(19) United States
(12) Patent Application Publication
(10) Pub. No.: US 2012/0222586 A1
(43) Pub. Date: Sep. 6, 2012

(54) HUMIDITY-CONTROLLING BUILDING MATERIAL AND METHOD FOR PRODUCING SAME

(75) Inventors: Hiroyoshi Sato, Chiyoda-ku (JP); Shinichi Matsushita, Chiyoda-ku (JP); Hironori Terada, Chiyoda-ku (JP)

(73) Assignee: ASAHI KASEI CONSTRUCTION MATERIALS CORPORATION, Tokyo (JP)

(21) Appl. No.: 13/504,431

(22) PCT Filed: Aug. 31, 2010
(86) PCT No.: PCT/JP2010/064790

§ 371 Date: May 18, 2012

(30) Foreign Application Priority Data
Oct. 27, 2009 (JP) 2009-246577

(51) Int. Cl. C04B 28/00; B28B 3/00

(52) U.S. Cl. 106/638; 264/86

(57) ABSTRACT

A humidity-controlling building material, which is produced by subjecting a molded product obtained by dehydration pressing a kneaded product of a hydraulic composition comprising an autoclaved lightweight aerated concrete powder and cement, and water; to autoclave curing, wherein a volume of pores with a diameter of 0.1 μm or more is 0.1 to 0.25 cc/g and a pore volume resulting from subtracting a volume of pores with a diameter of 0.1 μm or more from a total pore volume is 0.2 to 0.5 cc/g exhibits remarkably excellent performance in terms of both strength and moisture absorption and desorption performance.

### TECHNICAL FIELD

The present invention relates to a humidity-controlling building material and a method for producing the same.

### BACKGROUND ART

Recently in architecture, there is a trend toward high airtight and high thermal insulation structures in view of energy saving and an improvement in the living environment. Therefore, a humidity-controlling building material capable of absorption and desorption of moisture is demanded for buffering large humidity changes in the living space.

As a humidity-controlling building material, a product obtained by a production method of a humidity-controlling building material, comprising subjecting a hydraulic composition comprising a calcium silicate hydrate-containing powder and cement, wherein the hydraulic composition contains calcium metasilicate, to dehydration press molding, is known (Patent Literature 1).

### CITATION LIST

### Patent Literature

Patent Literature 1: Japanese Patent Application Laid-Open No. 2007-31267

### SUMMARY OF INVENTION

### Technical Problem

An object of the present invention is to provide a humidity-controlling building material exhibiting remarkably excellent performance in terms of both strength and moisture absorption and desorption performance compared to the existing humidity-controlling building materials and a method for producing the same.

### Solution to Problem

The present invention provides a humidity-controlling building material produced by subjecting, to autoclave curing, a molded product obtained by dehydration pressing of a kneaded product of a hydraulic composition comprising an autoclaved lightweight aerated concrete (ALC) powder and cement, and water; wherein a volume of pores with a diameter of 0.1 μm or more is 0.1 to 0.25 cc/g and a pore volume resulting from subtracting a volume of pores with a diameter of 0.1 μm or more from a total pore volume is 0.2 to 0.5 cc/g.

It is considered that a pore with a diameter of less than 0.1 μm, particularly a diameter of approximately 1 to 30 nm contributes to the moisture absorption and desorption performance; however, it was revealed that the moisture absorption and desorption performance of a humidity-controlling building material was successfully improved not by simply increasing the pore of the above size but by introducing a certain amount (0.1 to 0.25 cc/g in terms of pore volume) of pores larger than the above size, while maintaining a certain amount (0.2 to 0.5 cc/g in terms of pore volume) of the pore of the above size. It was further found that, regardless of the presence of a certain amount of the pore of the above size, the humidity-controlling building material attained practically sufficient material strength. That is, according to the humidity-controlling building material of the present invention, sufficient strength and high moisture absorption and desorption performance can be realized at the same time.

The present invention also provides a method for producing a humidity-controlling building material, comprising subjecting a kneaded product of a hydraulic composition comprising an autoclaved lightweight aerated concrete powder and cement, and water; to dehydration pressing, and then to autoclave curing, wherein an amount of the water is 90 to 130% by mass relative to the hydraulic composition.

According to the aforementioned production method, a volume of pores with a diameter of 0.1 μm or more of 0.1 to 0.25 cc/g can be achieved, and a pore volume resulting from subtracting the volume of pores with a diameter of 0.1 μm or more from the total pore volume of 0.2 to 0.5 cc/g can, be achieved, thereby enabling the production of a humidity-controlling building material having sufficient strength and high moisture absorption and desorption performance.

### Advantageous Effects of Invention

According to the present invention, a humidity-controlling building material having sufficient strength and high moisture absorption and desorption performance and a method for producing the same are provided.

### BRIEF DESCRIPTION OF DRAWINGS

FIG. 1 is a cross-sectional view of a mold that can be used in the molding process of the humidity-controlling building material.

FIG. 2 is a cross-sectional view showing the molding process using the mold of FIG. 1.

FIG. 3 is a cross-sectional view showing the molding process using a mold different from the mold of FIG. 1.

FIGS. 4(a) and (b) are photographs showing examples of the design surface of the humidity-controlling building material.

FIG. 5 is a graph showing the pore size distribution of the humidity-controlling building material.

FIG. 6 is a graph showing the pore size distribution of the humidity-controlling building material.

### DESCRIPTION OF EMBODIMENTS

Hereinbelow, preferred embodiments will be described with reference to the drawings as needed. In the explanation of the drawings, the same symbol is assigned to the same element to omit redundant explanation. Also, in the drawings, some parts are exaggerated for easy understanding, and thus the size and ratio are not necessarily consistent with the description.

The humidity-controlling building material according to the embodiments of the present invention is one resulting from subjecting a molded product obtained by dehydration pressing a kneaded product of a hydraulic composition containing an autoclaved lightweight aerated concrete (hereinbelow, may be referred to as ALC) powder and cement, and water; to autoclave curing, wherein the volume of pores with a diameter of 0.1 μm or more (hereinbelow, may be referred to as a “first pore volume”) and the pore volume resulting from subtracting the volume of pores with a diameter of 0.1 μm or more from the total pore volume (hereinbelow, may be referred to as a “second pore volume.” Also, the second pore volume may be rephrased as the volume of pores with a diameter of less than 0.1 μm) are in the following relationship:

The first pore volume: 0.1 to 0.25 cc/g

The second pore volume: 0.2 to 0.5 cc/g

Here, ALC is a product obtained by adding a foam generating agent such as a foaming agent and a gas forming agent to a slurry substance in which a siliceous material such as silica, cement, and a calcareous raw material such as unslaked lime are mixed, mixing the resulting mixture, allowing foaming to take place and the mixture to undergo hardening, and then subjecting the resulting product to autoclave curing. As the ALC powder, pulverized ALC, a product prepared by removing reinforcing materials from waste materials of ALC such as the remainder materials, timber offcuts, and powder of ALC produced in the production factory of ALC, the constructing and dismantling sites of ALC architecture, and the like, followed by pulverization, and the like are preferably used.

The volume mean particle diameter of the ALC powder is preferably 5 to 200 μm, more preferably 5 to 100 μm. When the volume mean particle diameter is larger than 200 μm, the coarse pore of the powder becomes a structural defect, causing a reduction in the strength of the humidity-controlling building material. When the volume mean particle diameter is smaller than 5 μm, pulverization of the ALC powder requires tremendous energy and time, which might lead to a reduction in the productivity.

As the cement, ordinary Portland cement, Portland blast-furnace cement, high early strength cement, moderate heat cement, jet cement, alumina cement, a mixed cement of Portland blast-furnace cement, silica cement, fly ash cement, and the like can be preferably used. These cements may be used singly or as a mixture thereof. When a color is added to the product using an inorganic pigment, an organic pigment, and the like, it is preferable to use white cement since color development is improved even when the pigment is added in a small amount,

A kneaded product is obtained from the aforementioned hydraulic composition containing the ALC powder and cement, and water; and the hydraulic composition may contain calcium metasilicate, which is a reinforcing material.

The hydraulic composition preferably contains 60 to 90 parts by mass, more preferably 70 to 85 parts by mass of the ALC powder relative to a total of 100 parts by mass of the ALC powder and cement. It is preferable that the hydraulic composition further contains 0.5 to 10 parts by mass of calcium metasilicate. A humidity-controlling building material having higher moisture absorption and desorption performance can be produced owing to the ratio between the ALC powder and cement being within the aforementioned range. Also, removal from the mold during molding becomes easy owing to the possession of calcium metasilicate by the hydraulic composition.

Also, as the calcium metasilicate, a naturally occurring product, an artificial mineral synthesized from a siliceous raw material and a calcareous raw material, and the like can be used. As to the form of calcium metasilicate, calcium metasilicate in the particulate form as well as in the fibrous form may be used. When calcium metasilicate in the fibrous form is used, an effect of increased strength of the humidity-controlling building material is obtained.

There may be a case that when the content of the ALC powder in the hydraulic composition is less than 60 parts by mass relative to a total of 100 parts by mass of the ALC powder and cement, the desorption speed of the resulting humidity-controlling building material is slowed down, whereas when the content of the ALC powder in the hydraulic composition exceeds 90 parts by mass relative to a total of 100 parts by mass of the ALC powder and cement, it takes a long time for the strength of a molded product obtained by dehydration press molding to reach such a level that the product can be handled, leading to a reduction in the productivity. Also, there may be a case that when the content of calcium metasilicate in, the hydraulic composition is less than 0.5 parts by mass relative to a total of 100 parts by mass of the ALC powder and cement, the effect of the addition of calcium metasilicate is not clearly manifested, whereas even when calcium metasilicate is added in an amount exceeding 10 parts by mass, an effect worth the amount added may not be obtained.

The hydraulic composition may further contain a reinforcing material as needed. As the reinforcing material, an organic fiber such as vinylon, NYLON (registered trademark), and pulp, an inorganic fiber such as carbon fiber, a metallic fiber such as stainless steel fiber, and the like are preferably used. Reinforcing steel such as a wire lath and an iron reinforcing mat may also be preferably used as the reinforcing material. The reinforcing material is preferably resistant to autoclave cure. A humidity-controlling building material produced from a hydraulic composition to which a reinforcing material has been added does not immediately break in the case that, for example, a crack is formed by an earthquake or the like, and thus the safety is increased.

The viscosity of the kneaded product is preferably 0.5 to 10 Pa·s, more preferably 1.0 to 8.5 Pa·s, even more preferably 1.7 to 4.9 Pa·s, and particularly preferably 2,70 to 4.54 Pa·s, As a viscosity adjusting method, a method of increasing or decreasing the amount of water added relative to the hydraulic composition and a method of adding a water reducing agent such as lignosulfonate and a derivative thereof, polycarboxylate and a derivative thereof, aminosulfonate and a derivative thereof, naphthalene and a derivative thereof, melamine sulfonate formaldehyde and a derivative thereof, and naphthalene sulfonate formaldehyde and a derivative thereof, or a combination of these methods can be used. As the water reducing agent, one kind of the aforementioned compounds can be used singly or as a mixture of two or more kinds thereof.

The amount of water added relative to an aqueous composition is preferably 90 to 130% by mass, more preferably 95 to 105% by mass. It should be noted that the mass ratio of the amount of water added relative to the hydraulic composition may be referred to as a “water ratio” in the present specification. It is possible to increase the first pore volume and improve the moisture absorption and desorption performance of the humidity-controlling building material owing to the amount of water added being within the aforementioned range. There is a tendency that when the amount of water added is less than 90% by mass of the hydraulic composition, the first pore volume of the humidity-controlling building material is decreased. Also, there is a tendency that when the humidity-controlling building material has a design surface, the number of visible openings in the design surface of the humidity-controlling building material is increased. There is a tendency that when the amount of water added exceeds 130% by mass of the hydraulic composition, the strength of the humidity-controlling building material is reduced. Also, there is a tendency that time required for dehydration in the dehydration press molding in the molding process to be described later is prolonged, leading to a reduction in the productivity.

In conventional cement-containing products, increasing the ratio of water relative to cement has been avoided because it leads to a reduction in strength and durability. In light of the above, normally, the amount of water added relative to cement has been limited to less than 90% by mass relative to the hydraulic composition. In contrast, by setting the amount of water added at the aforementioned ratio, the first pore volume can be increased while maintaining sufficient strength of the humidity-controlling building material, thereby producing a humidity-controlling building material having sufficient strength and high moisture absorption and desorption performance (large moisture absorption and desorption speed and moisture absorption and desorption capacity).

A kneading machine can be used for kneading the hydraulic composition and water. As the kneading machine, a mortar mixer, an Omni mixer, an Eirich mixer, a bi-axial forced-mixing mixer, and the like are preferably used.

Molding of a kneaded product is enabled by introducing a kneaded product obtained by the kneading process into a space (a molding space) formed by an upper mold and a lower mold of a mold having an upper mold and a lower mold and performing dehydration press. The humidity-controlling building material may or may not have a design surface.

The humidity-controlling building material described as above is producible via the kneading process for obtaining a kneaded product by kneading a hydraulic composition containing the ALC powder and cement, and water; the molding process for obtaining a molded product by subjecting the kneaded product to dehydration pressing, and the curing process in which the molded product is subjected to autoclave curing.

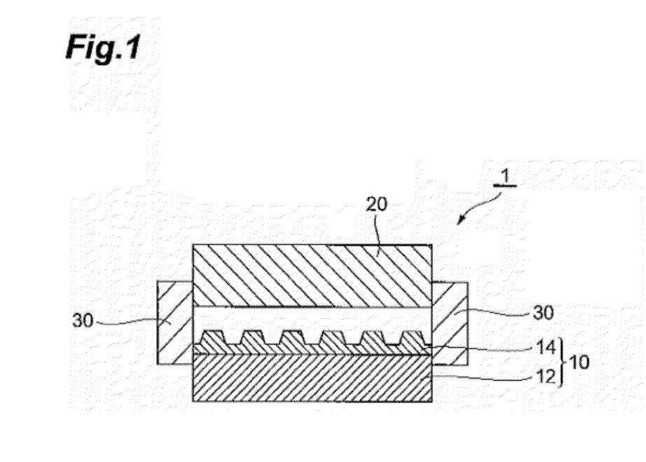

FIG. 1 is a cross-sectional view of a mold that can be used in the molding process of the humidity-controlling building material. A mold 1 shown in FIG. 1 has a lower mold 10, an upper mold 20, and an outer frame 30, and the lower mold 10 has a lower mold base 12 and a design mold 14.

In the mold 1, a space enclosed by the upper mold 20, the design mold 14, and the outer frame 30 is a molding space into which the kneaded product is introduced. Also, the surface of the upper mold 20 facing the molding space (i.e., the bottom surface of the upper mold 20. The surface of the upper mold 20 that is to contact the top surface of a molded product by dehydration pressing) serves as a dehydration surface through which water in the kneaded produced is drained out, and design is added to the molded product by concave and convex on the design mold 14, which faces the molding space.

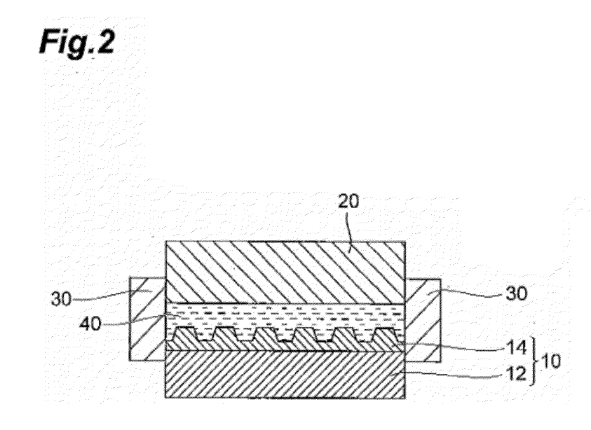

FIG. 2 is a cross-sectional view showing the molding process using the mold 1. In FIG. 2, a state in which a kneaded product 40 obtained by the kneading process is introduced into the molding space of the aforementioned mold 1 is shown. In the mold 1, the lower mold 10 is fixed, while the upper mold 20 and the outer frame 30 are mobile, and after introducing the kneaded product 40 into the molding space, the upper mold 20 is moved toward the lower mold 10 to press the kneaded product while draining water in the kneaded product out of the mold 1 through the dehydration surface of the upper mold 20, and adding design by concave and convex on the design mold 14. Dehydration press molding is thereby accomplished.

Although dehydration press molding may be performed by a method of squeezing water out by applying pressure or a method of applying pressure while forcedly dehydrating by reducing pressure; however, it is preferable to perform dehydration press molding by a method of removing water through the dehydration surface of the upper mold 20 by reducing pressure while applying pressure under the condition of 6 to 10 Mpa. The molded product is removed from the mold 1 after dehydration press molding.

It should be noted that the lower mold 10 and the outer frame 30 may be integrated, or the upper mold 20 and the outer frame 30 may be integrated. That is, the lower mold 10 and the outer frame 30 may compose the lower mold attached to the frame as a whole, or the upper mold 20 and the outer frame 30 may compose the upper mold attached to the frame as a whole.

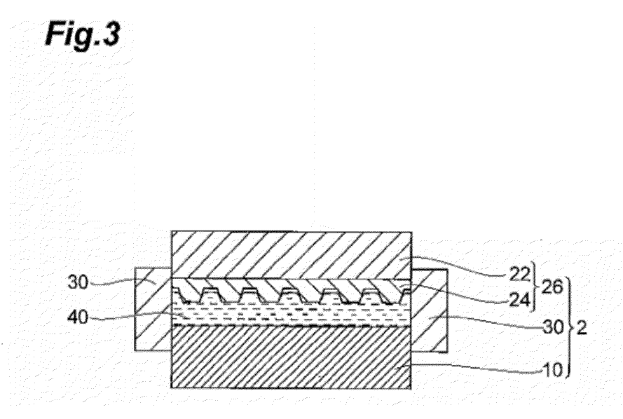

FIG. 3 is a cross-sectional view showing the molding process using a mold different from the mold 1. The mold 2 shown in FIG. 3 has the lower mold 10, an upper mold 26, and the outer frame 30, and the upper mold 26 has an upper mold base 22 and a design mold 24. Further, a space enclosed by the lower mold 10, the design mold 24, and the outer frame 30 is a molding space into which the kneaded product 40 is introduced. Also, the top surface of the lower mold 10 is a dehydration surface and the bottom surface of the design mold 24 (i.e., the surface of the design mold 24 that is to contact the molded product by dehydration pressing) is a design-imparting surface.

In the mold 2, the lower mold 10 is fixed, while the upper mold 26 and the outer frame 30 are mobile, and after introducing the kneaded product 40 into the molding space, the lower mold 26 is moved toward the lower mold 10 to press the kneaded product.

The curing process is performed following the molding process. In the curing process, the molded product obtained by the molding process is autoclave cured. Autoclave curing is preferably performed at 150 to 200° C., more preferably at 180 to 190° C. for 2 to 24 hours, more preferably for 4 to 12 hours. Before autoclave curing, for example, preliminary curing may be performed at room temperature for 0.5 to 12 hours.

In the humidity-controlling building material of the present embodiment, the first pore volume is 0.1 to 0.25 cc/g and the second pore volume is 0.2 to 0.5 cc/g. The pore size distribution of the humidity-controlling building material can be measured by the mercury press-in method using a mercury porosimeter (for example, the product of CARLO ERBA INSTRUMENTS, trade names “Pascal 140” and “Pascal 440”). The range of pressure measurement is, for example, 0.3 to 400 kPa (in the case of “Pascal 140”) or 0.1 to 400 MPa (in the case of “Pascal 440”).

The large first pore volume of the humidity-controlling building material is considered to contribute to improve the diffusion efficiency of water vapor and improve the moisture absorption and desorption performance of the humidity-controlling building material. However, there may be a case that when the first pore volume exceeds 0.25 cc/g, the strength of the humidity-controlling building material is reduced. Also, there may be a case that when the first pore volume is less than 0.1 cc/g, the moisture absorption and desorption performance of the humidity-controlling building material is insufficient.

The large second pore volume of the humidity-controlling building material contributes to improve the moisture absorption and desorption performance. Particularly, pores with a diameter of 1 to 30 nm are considered to affect adsorption of water vapor. In the production of the humidity-controlling building material, when the autoclave curing time is prolonged, crystals of tobermorite become dense, leading to an increase in the second pore volume. However, when a humidity-controlling building material in which the second pore volume exceeds 0.5 cc/g is produced, productivity may be reduced due to the prolonged time required for the production. Further, there may be a case that when the second pore volume is less than 0.2 cc/g, the moisture absorption and desorption performance of the humidity-controlling building material is insufficient.

The main components of the aforementioned humidity-controlling building material may be tobermorite and quartz. Here, the phrase “the main components . . . may be tobermorite and quartz” means that the top two in terms of the percentage content are tobermorite (including the tobermorite precursor C—S—H gel) and quartz. Also, as the components other than tobermorite and quartz, the humidity-controlling building material can contain a compound produced due to changes in tobermorite over time such as calcium carbonate and amorphous silicic acid, inorganic mineral such as zeolite, diatomaceous earth, allophane, sepiolite, and halloysite, and a coloring material such as iron oxide, iron hydroxide, and titanium oxide.

As a modified embodiment of the present invention, a method for producing a humidity-controlling building material, which includes the kneading process for obtaining a kneaded product by kneading a hydraulic composition containing a calcium silicate hydrate-containing powder, cement, and calcium metasilicate, and water; and the molding process for obtaining a molded product by introducing the kneaded product into a space formed by an upper mold and a lower mold of a mold having the upper mold and the lower mold and then performing dehydration pressing, wherein the surface of the upper mold, which is to contact the upper surface of the molded product, serves as a dehydration surface through which water in the kneaded product is drained out and the surface of the lower mold, which is to contact the lower surface of the molded product by dehydration pressing, serves as a design surface, which imparts design to the molded product, wherein the viscosity of the kneaded product is 1.7 to 4.9 Pa·s, is provided. In this method, the amount of water is preferably 100 to 130% by mass relative to the hydraulic composition.

According to the above-described production method, a humidity-controlling building material having large moisture absorption and desorption speed and moisture absorption and desorption capacity as well as a markedly reduced number of visible openings in the design surface can be produced.

The aforementioned hydraulic composition preferably contains 60 to 90 parts by mass of the calcium silicate hydrate-containing powder, 40 to 10 parts by mass of cement, and 0.5 to 10 parts by mass of calcium metasilicate relative to a total of 100 parts by mass of the calcium silicate hydrate-containing powder and cement. The above-described composition enables the production of a humidity-controlling building material having larger moisture absorption and desorption speed and moisture absorption and desorption capacity.

The aforementioned calcium silicate hydrate-containing powder is more preferably an ALC powder. Although the waste material of ALC has conventionally been disposed by landfill, considering that disposal by landfill imposes a heavy environmental burden and also securing land will be difficult in the future, a disposal method alternative to disposal by landfill is demanded. Utilization of the ALC powder produced from the waste material of ALC as a raw material of the humidity-controlling building material enables effective recycle of the waste material of ALC, thereby solving the problem of disposal of the waste material of ALC.

### EXAMPLES

Hereinbelow, the present invention will be described in further detail with reference to Examples of the present invention. However, the present invention is not limited to these Examples, and various modifications may be made without departing from the technical concept of the present invention.

### Example 1

As the ALC powder, pulverized waste materials of ALC were used. Specifically, fine powder having a volume mean particle diameter of 45 μm obtained by coarsely crushing the ALC offcuts produced in the process of trimming down ALC in an ALC production factory with a jaw crusher, and then finely crushing the resulting product with a high-speed rotating hammer mill was used. The volume mean particle diameter was measured using the laser particle size distribution measuring instrument 9320HRA (Microtrac Inc.). Here, the volume mean particle diameter means the 50% diameter, i.e., the median diameter. As the cement, white cement was used. As the calcium metasilicate, one in the fibrous form (NYCO MINERALS INC., NYAD-G grade) was used.

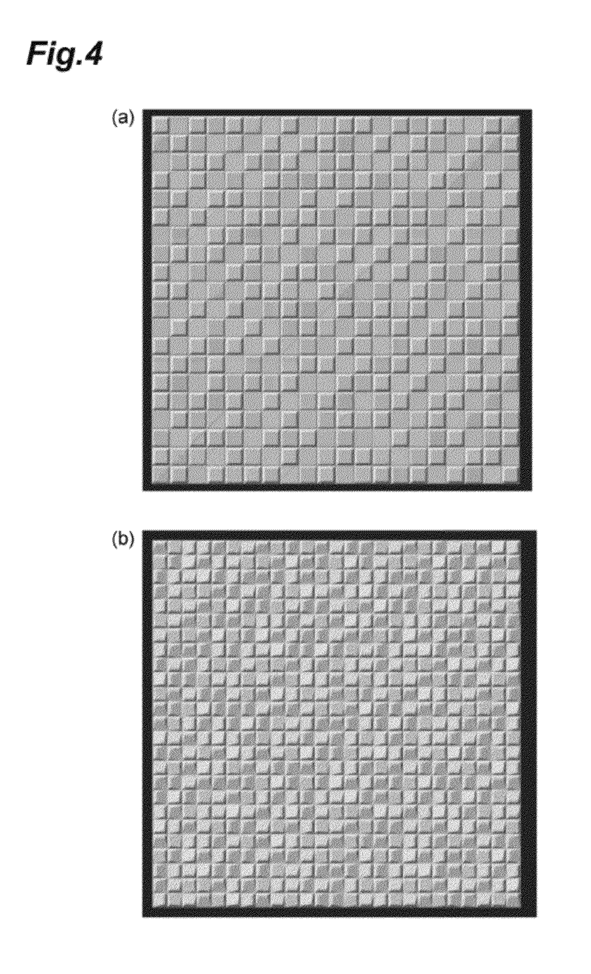

To a hydraulic composition composed of 75 parts by mass of ALC powder, 25 parts by mass of cement, and 2 parts by mass of calcium metasilicate, water was added in an amount of 90% by mass of the hydraulic composition, followed by kneading with an Omni mixer. The viscosity of the kneaded produced upon completion of the kneading was 8.5 Pa·s. The kneaded product thus obtained was placed in a mold having the same configuration as the mold 1 of FIG. 1, and subjected to dehydration press molding, which involved dehydrating by reducing pressure on the dehydration surface side while applying pressure under the condition of a pressure of 7 Mpa, to give a molded product. The form of the design surface of the molded product is shown in FIG. 4(a). The size of the molded product was 30.3 cm×30.3 cm. The molded product thus obtained was preliminarily cured at room temperature, and then subjected to autoclave curing under the condition of 180° C. for four hours, whereby the humidity-controlling building material of Example 1 was obtained.

### Example 2

Except for changing the amount of water added to 100% by mass of the hydraulic composition, the humidity-controlling building material of Example 2 was obtained in the same manner as Example 1.

### Example 3

Except for changing the amount of water added to 110% by mass of the hydraulic composition, the humidity-controlling building material of Example 3 was obtained in the same manner as Example 1.

### Example 4

Except for changing the amount of water added to 120% by mass of the hydraulic composition, the humidity-controlling building material of Example 4 was obtained in the same manner as Example 1.

### Example 5

Except for changing the amount of water added to 120% by mass of the hydraulic composition and the autoclave curing time to eight hours, the humidity-controlling building material of Example 5 was obtained in the same manner as Example 1.

### Example 6

Except for changing the amount of water added to 130% by mass of the hydraulic composition, the humidity-controlling building material of Example 6 was obtained in the same manner as Example 1.

### Example 7

Except for changing the amount of water added to 100% by mass of the hydraulic composition and the condition of autoclave curing to 190° C. for 12 hours, the humidity-controlling building material of Example 7 was obtained in the same manner as Example 1.

### Example 8

Except for adding a water reducing agent mainly composed of polycarboxylic acid and a derivative thereof in an amount of 0.8% by mass of the hydraulic composition as a viscosity adjusting agent, the humidity-controlling building material of Example 8 was obtained in the same manner as Example 1.

### Comparative Example 1

Except for changing the amount of water added to 70% by mass of the hydraulic composition, the humidity-controlling building material of Comparative Example 1 was obtained in the same manner as Example 1.

### Comparative Example 2

Except for changing the amount of water added to 80% by mass of the hydraulic composition, the humidity-controlling building material of Comparative Example 2 was obtained in the same manner as Example 1.

### Comparative Example 3

Except for changing the amount of water added to 140% by mass of the hydraulic composition, the humidity-controlling building material of Comparative Example 3 was obtained in the same manner as Example 1.

### Comparative Example 4

Except for changing the amount of water added to 150% by mass of the hydraulic composition, the humidity-controlling building material of Comparative Example 4 was obtained in the same manner as Example 1.

### Comparative Example 5

For reference, the measurement to be described below was made using ALC per se as the humidity-controlling building material of Comparative Example 5.

### Reference Example 1

As the ALC powder, pulverized waste materials of ALC were used. Specifically, fine powder having a volume mean particle diameter of 45 μm obtained by coarsely crushing the ALC offcuts produced in the process of trimming down ALC in an ALC production factory with a jaw crusher, and then finely crushing the resulting product with a high-speed rotating hammer mill was used. The volume mean particle diameter was measured using the laser particle size distribution measuring instrument 9320HRA (Microtrac Inc.). Here, the volume mean particle diameter means the 50% diameter, i.e., the median diameter. As the cement, white cement was used. As the calcium metasilicate, one in the fibrous form (NYCO MINERALS INC., NYAD-G grade) was used.

To a hydraulic composition composed of 75 parts by mass of ALC powder, 25 parts by mass of cement, and 2 parts by mass of calcium metasilicate, water was added in an amount of 110% by mass of the hydraulic composition, followed by kneading with an Omni mixer. The kneaded product thus obtained was placed in a mold having the same configuration as the mold 1 of FIG. 1, and subjected to dehydration press molding, which involved dehydrating by reducing pressure on the dehydration surface side while applying pressure under the condition of a pressure of 7 Mpa, to give a molded product. The form of the design surface of the molded product is shown in FIG. 4(a). The size of the molded product was 30.3 cm×30.3 cm. The molded product thus obtained was preliminarily cured at room temperature, and then subjected to autoclave curing under the condition of 180° C. for four hours, whereby the humidity-controlling building material of Reference Example 1 was obtained.

### Reference Example 2

Except for changing the amount of water added to 120% by mass of the hydraulic composition, the humidity-controlling building material of Reference Example 2 was obtained in the same manner as Reference Example 1.

### Reference Example 3

Except for preparing the design form of the molded product as shown in FIG. 4(b), the humidity-controlling building material of Reference Example 3 was obtained in the same manner as Reference Example 1.

### Reference Example 4

Except for changing the amount of water added to 120% by mass of the hydraulic composition, the humidity-controlling building material of Reference Example 4 was obtained in the same manner as Reference Example 3.

### Reference Example 5

Except for changing the amount of water added to 80% by mass of the hydraulic composition and carrying out the dehydration press molding using a mold having the same configuration as the mold 2 of FIG. 3, the humidity-controlling building material of Reference Example 5 was obtained in the same manner as Reference Example 1.

### Reference Example 6

Except for changing the amount of water added to 80% by mass of the hydraulic composition, the humidity-controlling building material of Reference Example 6 was obtained in the same manner as Reference Example 1.

### Reference Example 7

Except for carrying out the dehydration press molding using a mold having the same configuration as the mold 2 of FIG. 3, the humidity-controlling building material of Reference Example 7 was obtained in the same manner as Reference Example 1.

### Reference Example 8

Except for changing the amount of water added to 80% by weight of the hydraulic composition and carrying out the dehydration press molding using a mold having the same configuration as the mold 2 of FIG. 3, the humidity-controlling building material of Reference Example 8 was obtained in the same manner as Reference Example 3.

### Reference Example 9

Except for changing the amount of water added to 80% by mass % of the hydraulic composition, the humidity-controlling building material of Reference Example 9 was obtained in the same manner as Reference Example 3.

### Reference Example 10

Except for carrying out the dehydration press molding using a mold having the same configuration as the mold 2 of FIG. 3, the humidity-controlling building material of Reference Example 10 was obtained in the same manner as Reference Example 3.

The following measurements were made using the humidity-controlling building materials of Examples, Comparative Examples, and Reference Examples as the samples. The results are shown in Tables 1 to 3.

(Measurement of the Viscosity of the Kneaded Product)

The viscosity of the kneaded product was measured by a rotational viscometer (Brookfield, the model HAT) equipped with a rotor (HA/HB spindle No. 3) at a rotational speed of 10 rpm.

(Measurement of Density)

The humidity-controlling building material was immersed in water and the apparent mass in water m₁ was measured. Subsequently, the humidity-controlling building material was removed from water and the surface was wiped, and the mass m₂ was measured. Subsequently, the humidity-controlling building material was dried using a dryer at 105° C. for three days, and the absolute dry mass m₃ was measured, By setting the density of water at 1 g/cm³, the density of the humidity-controlling building material (g/cm³) was calculated by the following formula (1). The measurement results each represent an average value of 10 sheets.

Density=m₃/(m₂−m₁) (1)

(Pore Size Distribution)

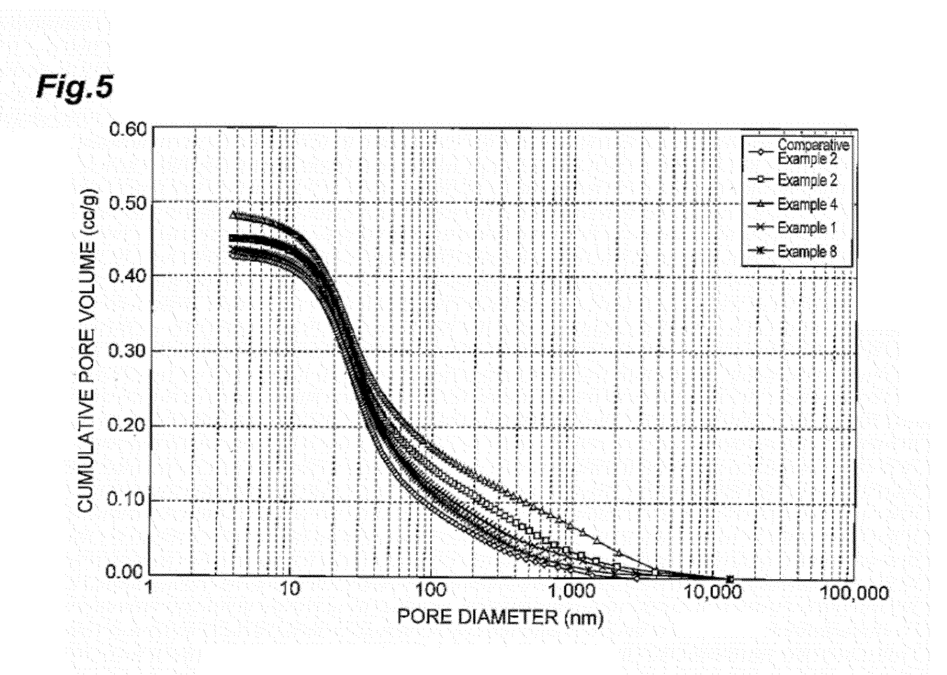

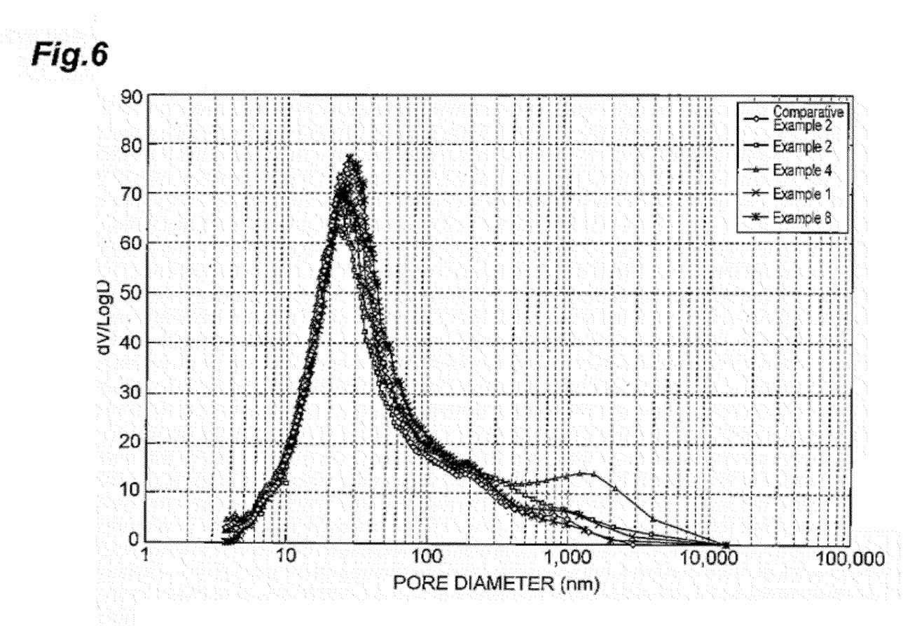

The pore size distribution was measured by the mercury press-in method using a mercury porosimeter (the product of CARLO ERBA INSTRUMENTS, trade names “Pascal 140” and “Pascal 440”). The results are shown in Table 1 and FIGS. 5 and 6. In Table 1, the first pore volume, the total pore volume, and the second pore volume are indicated as (a), (b), and “b-a”, respectively.

FIG. 5 is a graph showing the results of measurements of the pore size distribution of the humidity-controlling building materials of Comparative Example 2 (water ratio 0.8), Example 1 (water ratio 0.9), Example 8 (water ratio 0.9), Example 2 (water ratio 1.0), and Example 4 (water ratio 1.2). The abscissa indicates the pore diameter, and the ordinate indicates the cumulative pore volume. FIG. 6 is a graph showing the results of the pore size distribution of FIG. 5 that have been differentiated. In FIG. 6, V indicates the pore volume and D indicates the pore diameter.

(Measurement of the Bending Fracture Load)

The bending fracture load (N) of the humidity-controlling building material was measured. First of all, the moisture percentage of the humidity-controlling building material was adjusted to approximately 10% by hot air circulation type dryer at 40° C. Subsequently, the fracture load F was measured by the bisector one point load method with a support point span of 180 mm and a loading speed of 0.1 cm/minute, and the bending fracture load (S) was calculated by the following formula (2). In the formula (2), F indicates the fracture load (N), b indicates the width (min) of a tested material, and L indicates the support span (mm). The measurement results each represent an average value of 10 sheets.

S=F×L/b (2)

(Powder X-Ray Diffraction)

Using a common powder X-ray diffractometer, the components of the humidity-controlling building material were measured. The main components (crystalline phase) identified by the analysis are shown in Table 1.

(Measurement of Water Penetration Value)

The water penetration value of the humidity-controlling building material was measured by a method in accordance with the water penetration test method B of “the coating material for textured finishes of buildings HS A 6909.” First of all, the humidity-controlling building material was kept horizontal. Subsequently, a water penetration test jig, in which a measuring pipette was mounted on a funnel with a diameter of 75 mm by a rubber tube or a vinyl chloride tube, was fixed onto the humidity-controlling building material with a silicone sealing material, and after leaving the resulting humidity-controlling building material as is for 48 hours or longer, water at 23±2° C. was poured up to a height of 250 mm from the surface of the humidity-controlling building material, and the difference between the height of the hydraulic head at the initiation of the test and the height of the hydraulic head after 24 hours was measured, which was obtained as the water penetration value.

(Measurement of the Moisture Absorption and Desorption Performance)

The moisture absorption and desorption performance (moisture absorption performance and moisture desorption performance) of the humidity-controlling building materials of Examples and Comparative Examples was measured. The measurement was performed by a method in accordance with “Determination of water vapour adsorption/desorption properties for building materials JIS A 1470-1:2008.” First of all, five surfaces out of six surfaces of the humidity-controlling building material were covered with aluminum tape to make them moisture proof, leaving only one surface (250 mm×250 mm) uncovered. Subsequently, the resulting humidity-controlling building material was left as is under the condition of a relative humidity of 53% until the mass became constant. Subsequently, the relative humidity was changed to 75% and the humidity-controlling building material was left as is for 12 hours, and the moisture absorption amount (moisture absorption performance) was measured from the mass change of the humidity-controlling building material. Subsequently, the relative humidity was returned to 53% and the humidity-controlling building material was left as is for 12 hours, and the moisture desorption amount (moisture desorption performance) was measured from the mass change. The measurement results each represent an average value of two sheets. The measurement results are shown in Table 1.

The moisture absorption and desorption performance of the humidity-controlling building materials of Reference Examples 1 to 10 was also measured. However, the measurement method was carried out in accordance with “Determination of water vapour adsorption/desorption properties for building materials HS A 1470-1:2002”, and the moisture absorption and desorption performance in a high humidity range was measured. The measurement results each represent an average value of two sheets. The measurement results are shown in Tables 2 and 3.

(Measurement of Openings in the Design Surface)

The number of visible openings remaining on the design surface of the humidity-controlling building material per sheet was measured in the humidity-controlling building materials of Reference Examples 1 to 10. The measurement results each represent an average value of 10 sheets, The opening was found to be in the squashed sphere-like form. with a diameter of 1 mm or more. The results are shown in Tables 2 and 3. Compared to the humidity-controlling building materials of Reference Examples 5 to 10, the number of visible openings remaining on the design surface of the humidity-controlling building materials of Reference Examples 1 to 4 was found to be markedly reduced.

TABLE 1

| | Comparative | Comparative | | | | |
|---|---|---|---|---|---|---|
| | Example 1 | Example 2 | Example 1 | Example 2 | Example 7 | Example 3 |
| Water ratio | 0.7 | 0.8 | 0.9 | 1.0 | 1.0 | 1.1 |
| Viscosity of kneaded product (Pa · s) | 54.46 | 19.94 | 8.50 | 3.80 | 3.80 | 1.95 |
| Density | 1.172 | 1.178 | 1.168 | 1.174 | 1.126 | 1.170 |
| Volume of pores with a diameter of 0.1 μm | 0.07 | 0.09 | 0.12 | 0.15 | 0.12 | 0.16 |
| or more (a) (cc/g) | | | | | | |
| Total pore volume (b) (cc/g) | 0.37 | 0.43 | 0.44 | 0.46 | 0.56 | 0.47 |
| b − a (cc/g) | 0.30 | 0.34 | 0.32 | 0.31 | 0.44 | 0.31 |
| Specific surface area (m²/g) | 59.2 | 60.8 | 57.8 | 57.0 | 59.6 | 59.1 |
| Mean pore diameter (nm) | 29.3 | 33.9 | 37.8 | 40.5 | 41.7 | 43.4 |
| Bending fracture load (N) | 153.9 | 154.8 | 154.8 | 155.7 | 153.9 | 154.8 |
| Powder X-ray diffraction | Tobermorite, | Tobermorite, | Tobermorite, | Tobermorite, | Tobermorite, | Tobermorite, |
| | Silica, | Silica, | Silica, | Silica, | Silica, | Silica, |
| | Wollastonite | Wollastonite | Wollastonite | Wollastonite | Wollastonite | Wollastonite |
| Water penetration value (cc/day) | 29.5 | 30.3 | 31.1 | 32.5 | 32.5 | 32.6 |
| Moisture absorption performance | 42.8 | 43.6 | 43.6 | 44.3 | 45.0 | 45.2 |
| (12 hours, 75%) (g/m²) | | | | | | |
| Moisture desorption performance | 25.9 | 26.6 | 30.5 | 32.3 | 32.6 | 33.5 |
| (12 hours, 50%) (g/m²) | | | | | | |
| | | | | Comparative | Comparative | Comparative |
| | Example 4 | Example 5 | Example 6 | Example 3 | Example 4 | Example 5 |
| Water ratio | 1.2 | 1.2 | 1.3 | 1.4 | 1.5 | |
| Viscosity of kneaded product (Pa · s) | 1.00 | 1.00 | 0.60 | 0.55 | 0.45 | |
| Density | 1.157 | 1.158 | 1.148 | 1.139 | 1.121 | 0.500 |
| Volume of pores with a diameter of 0.1 μm | 0.17 | 0.18 | 0.21 | 0.26 | 0.3 | 0.39 |
| or more (a) (cc/g) | | | | | | |
| Total pore volume (b) (cc/g) | 0.48 | 0.57 | 0.52 | 0.60 | 0.60 | 0.88 |
| b − a (cc/g) | 0.31 | 0.39 | 0.31 | 0.34 | 0.30 | 0.49 |
| Specific surface area (m²/g) | 61.2 | 62.2 | 62.5 | 63.4 | 64.0 | |
| Mean pore diameter (nm) | 44.3 | 44.7 | 45.0 | 47.6 | 48.7 | |
| Bending fracture load (N) | 153.9 | 153.0 | 151.2 | 139.5 | 128.7 | |
| Powder X-ray diffraction | Tobermorite, | Tobermorite, | Tobermorite, | Tobermorite, | Tobermorite, | Tobermorite, |
| | Silica, | Silica, | Silica, | Silica, | Silica, | Silica, |
| | Wollastonite | Wollastonite | Wollastonite | Wollastonite | Wollastonite | Gypsum |
| Water penetration value (cc/day) | 32.7 | 32.8 | 34.6 | 39.4 | 43.5 | |
| Moisture absorption performance | 47.2 | 47.3 | 47.6 | 47.9 | 48.2 | |
| (12 hours, 75%) (g/m²) | | | | | | |
| Moisture desorption performance | 35.4 | 35.6 | 35.6 | 35.8 | 36.1 | |
| (12 hours, 50%) (g/m²) | | | | | | |

TABLE 2

| | Refer- | Refer- | Refer- | Refer- | Refer- |
|---|---|---|---|---|---|
| | ence | ence | ence | ence | ence |
| | Exam- | Exam- | Exam- | Exam- | Exam- |
| | ple 1 | ple 2 | ple 3 | ple 4 | ple 1 |
| Form of design surface | (a) | (a) | (b) | (b) | (a) |
| Amount of water added | 110 | 120 | 110 | 120 | 80 |
| (% by mass relative to | | | | | |
| hydraulic composition) | | | | | |
| Viscosity of kneaded | 4.54 | 2.70 | 4.54 | 2.70 | 8.84 |
| product (Pa · s) | | | | | |
| Position of dehydration | Top | Top | Top | Top | Bottom |
| surface | side | side | side | side | side |
| Density (g/cm³) | 1.13 | 1.13 | 1.12 | 1.12 | 1.11 |
| Bending fracture load | 154 | 154 | 153 | 153 | 150 |
| (N) | | | | | |
| Moisture absorption | 230 | 230 | 230 | 230 | 230 |
| and desorption | | | | | |
| performance (g/m²) | | | | | |
| The number of visible | 11 | 11 | 15 | 13 | 196 |
| openings remaining on | | | | | |
| the design surface | | | | | |

TABLE 3

| | Refer- | Refer- | Refer- | Refer- | Refer- |
|---|---|---|---|---|---|
| | ence | ence | ence | ence | ence |
| | Exam- | Exam- | Exam- | Exam- | Exam- |
| | ple 2 | ple 3 | ple 4 | ple 5 | ple 6 |
| Form of design surface | (a) | (a) | (b) | (b) | (b) |
| Amount of water added | 80 | 110 | 80 | 80 | 110 |
| (% by mass relative to | | | | | |
| hydraulic composition) | | | | | |
| Viscosity of kneaded | 8.84 | 4.54 | 8.84 | 8.84 | 4.54 |
| product (Pa · s) | | | | | |
| Position of dehydration | Top | Bottom | Bottom | Top | Bottom |
| surface | side | side | side | side | side |
| Density (g/cm³) | 1.11 | 1.11 | 1.10 | 1.10 | 1.10 |
| Bending fracture load | 150 | 150 | 149 | 149 | 149 |
| (N) | | | | | |
| Moisture absorption | 230 | 230 | 230 | 230 | 230 |
| and desorption | | | | | |
| performance (g/m²) | | | | | |
| The number of visible | 180 | 200 | 232 | 225 | 240 |
| openings remaining on | | | | | |
| the design surface | | | | | |

### INDUSTRIAL APPLICABILITY

According to the present invention, a humidity-controlling building material exhibiting remarkably excellent performance in terms of both strength and moisture absorption and desorption performance and a method for producing the same are provided.

### REFERENCE SIGNS LIST

1, 2 . . . Mold; 10 . . . Lower mold; 12 . . . Lower mold base; 14, 24 . . . Design mold; 20, 26 . . . Upper mold; 22 . . . Upper mold base; 30 . . . Outer frame; 40 . . . kneaded product

1. A humidity-controlling building material produced by subjecting a kneaded product of
a hydraulic composition comprising an autoclaved lightweight aerated concrete powder and cement, and
water,
to dehydration pressing, and then to autoclave curing, wherein
a volume of pores with a diameter of 0.1 μm or more is 0.1 to 0.25 cc/g, and
a pore volume resulting from subtracting a volume of pores with a diameter of 0.1 μm or more from a total pore volume is 0.2 to 0.5 cc/g.

2. A method for producing a humidity-controlling building material, comprising subjecting a kneaded product of
a hydraulic composition comprising an autoclaved lightweight aerated concrete powder and cement, and
water,
to dehydration pressing, and then to autoclave curing, wherein
an amount of the water is 90 to 130% by mass relative to the hydraulic composition.
